(19) United States
(12) Patent Application Publication
(10) Pub. No.: US 2011/0221706 A1
(43) Pub. Date: Sep. 15, 2011

(54) TOUCH INPUT WITH IMAGE SENSOR AND SIGNAL PROCESSOR

(75) Inventors: Grant McGibney, Calgary (CA); Clinton Lam, Calgary (CA)

(73) Assignee: SMART TECHNOLOGIES ULC, Calgary (CA)

(21) Appl. No.: 13/063,920

(22) PCT Filed: Sep. 15, 2009
(86) PCT No.: PCT/CA09/01261

§ 371 Date: May 25, 2011

Related U.S. Application Data
(60) Provisional application No. 61/097,206, filed on Sep. 15, 2008.

(51) Int. Cl. G06F 3/042

(52) U.S. Cl. 345/175

(57) ABSTRACT

An interactive input system comprises at least two imaging assemblies capturing image frames of a region of interest from different vantages and processing structure processing image frames captured by the imaging assemblies to determine the location of a pointer within the region of interest, wherein each imaging assembly comprises an image sensor and integrated signal processing circuitry.

### CROSS-REFERENCE TO RELATED APPLICATIONS

This application is a continuation-in-part of U.S. patent application Ser. No. 12/118,545 to Hansen et al. filed on May 9, 2008 and entitled “Interactive Input System and Bezel Therefor”, the content of which is incorporated herein by reference. This application also claims the benefit of U.S. Provisional Application No. 61/097,206 to McGibney et al. filed on Sep. 15, 2008 entitled “Interactive Input System”, the content of which is incorporated herein by reference.

### FIELD OF THE INVENTION

The present invention relates to an interactive input system.

### BACKGROUND OF THE INVENTION

Interactive input systems that allow users to inject input (eg. digital ink, mouse events etc.) into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

Although many different types of interactive input systems exist, improvements to such interactive input systems are continually being sought. It is therefore an object of the present invention to provide a novel interactive input system.

### SUMMARY OF THE INVENTION

Accordingly, in one aspect there is provided an interactive input system comprising at least two imaging assemblies capturing image frames of a region of interest from different vantages; and processing structure processing image frames captured by said imaging assemblies to determine the location of a pointer within the region of interest, wherein each imaging assembly comprises an image sensor and integrated signal processing circuitry.

According to another aspect there is provided an interactive input system comprising at least one imaging device having a field of view looking into a region of interest; and at least one radiation source emitting radiation into said region of interest, wherein during image frame capture by said at least one imaging device, the operation of the at least one radiation source is synchronized with the exposure time of said at least one imaging device

### BRIEF DESCRIPTION OF THE DRAWINGS

Embodiments will now be described more fully with reference to the accompanying drawings in which:

FIG. 1 is a perspective view of an interactive input system;

FIG. 2 is a block diagram view of the interactive input system of FIG. 1;

FIG. 3 is a perspective conceptual view of a portion of the interactive input system of FIG. 1;

FIG. 4A is a block diagram of an image sensor and associated signal processing circuitry forming part of the interactive input system of FIG. 1;

FIG. 4B is a block diagram of another embodiment of the image sensor and associated signal processing circuitry for the interactive input system of FIG. 1;

FIG. 5 is another schematic diagram block diagram of the image sensor and associated signal processing circuitry of FIG. 4A;

FIGS. 6A and 6B are block diagrams of further alternative image sensors and associated signal processing circuitry for the interactive input system of FIG. 1; and

FIGS. 7A and 7B are block diagrams of still further alternative image sensors and associated signal processing circuitry for the interactive input system of FIG. 1.

### DETAILED DESCRIPTION OF THE EMBODIMENTS

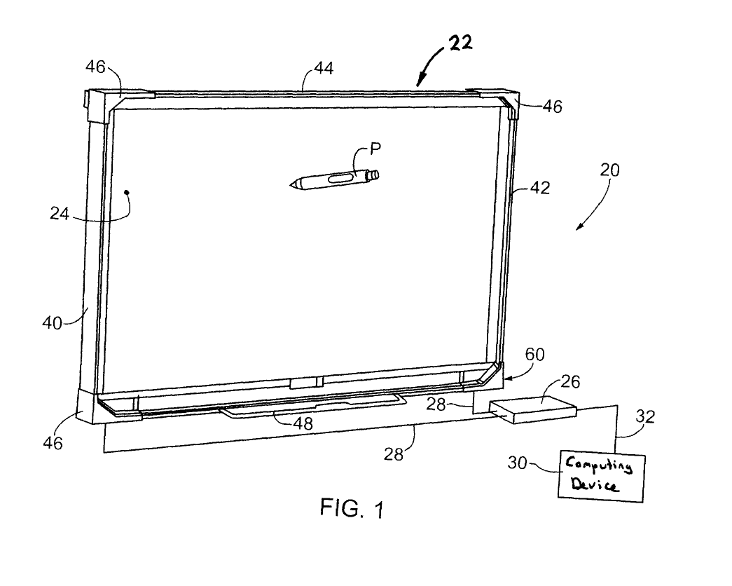

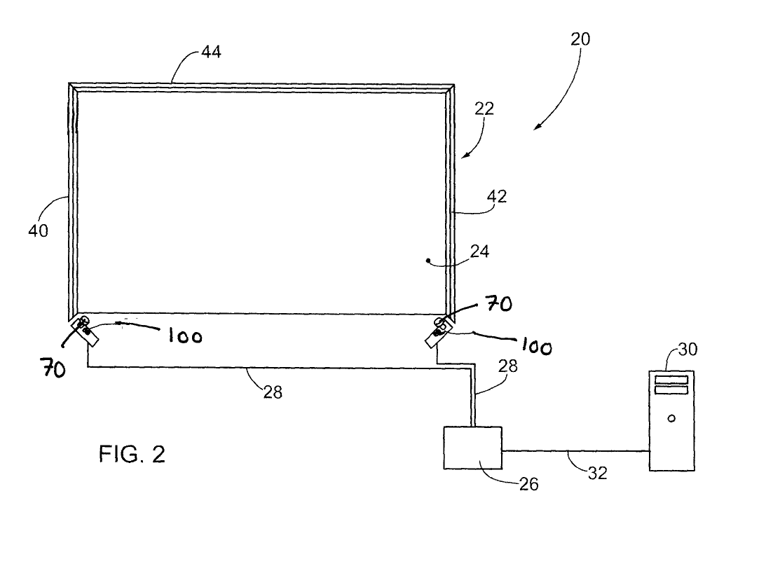

Turning now to FIGS. 1 to 3, an interactive input system that allows a user to inject input (eg. digital ink, mouse events etc.) into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into a region of interest in proximity with the display surface 24 and communicates with a central hub 26 via communication lines 28. The communication lines 28 in this embodiment are embodied in a serial bus.

The central hub 26 also communicates with a general purpose computing device 30 executing one or more application programs via a USB cable 32. Computing device 30 comprises for example a processing unit, system memory (volatile and/or non-volatile), other non-removable or removable memory (a hard disk drive, RAM, ROM, EEPROM, CD-ROM, DVD, flash memory etc.) and a system bus coupling the various computing device components to the processing unit. The computing device 30 processes the image data output of the assembly 22 received via the central hub 26 and adjusts image data that is output to the display unit so that the image presented on the display surface 24 reflects pointer activity. In this manner, the assembly 22, central hub 26 and computing device 30 allow pointer activity proximate to the display surface 24 and within the region of interest to be recorded as writing or drawing or used to control execution of one or more application programs executed by the computing device 30.

Assembly 22 comprises a frame assembly that is mechanically attached to the display unit and surrounds the display surface 24. Frame assembly comprises a bezel having three bezel segments 40, 42 and 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 also accommodate imaging assemblies 60 that look generally across the entire display surface 24 from different vantages. The bezel segments 40, 42 and 44 are oriented so that their inwardly facing surfaces are seen by the imaging assemblies 60.

In this embodiment, the inwardly facing surface of each bezel segment 40, 42, 44 comprises a single strip or band of retro-reflective material. To take best advantage of the properties of the retro-reflective material, the bezel segments 40, 42 and 44 are oriented so that their inwardly facing surfaces lie in planes that are generally normal to the plane of the display surface 24. Alternatively, the bezel segments 40, 42 and 44 may be of the type disclosed in above-incorporated U.S. patent application Ser. No. 12/118,545 to Hansen et al.

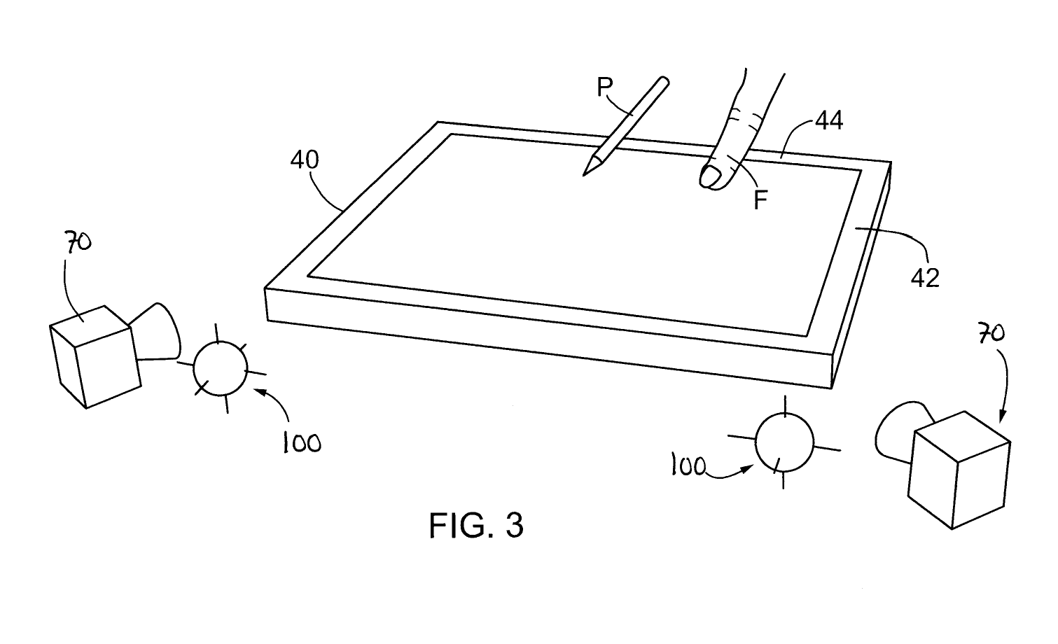

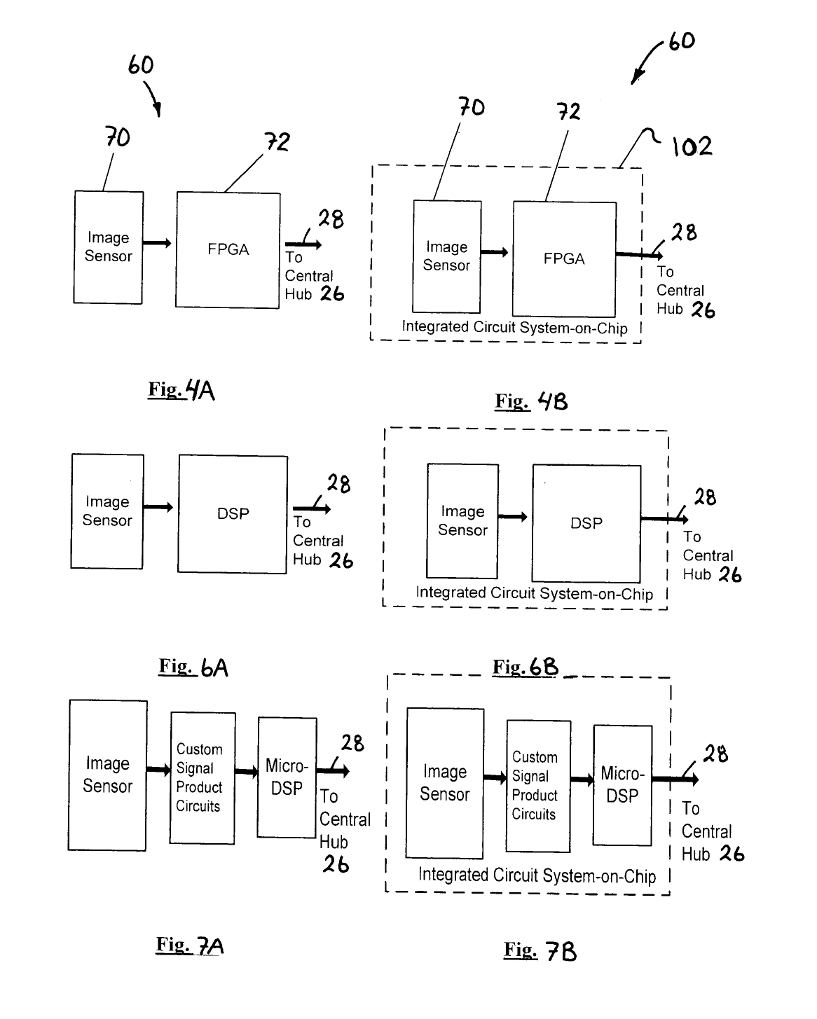

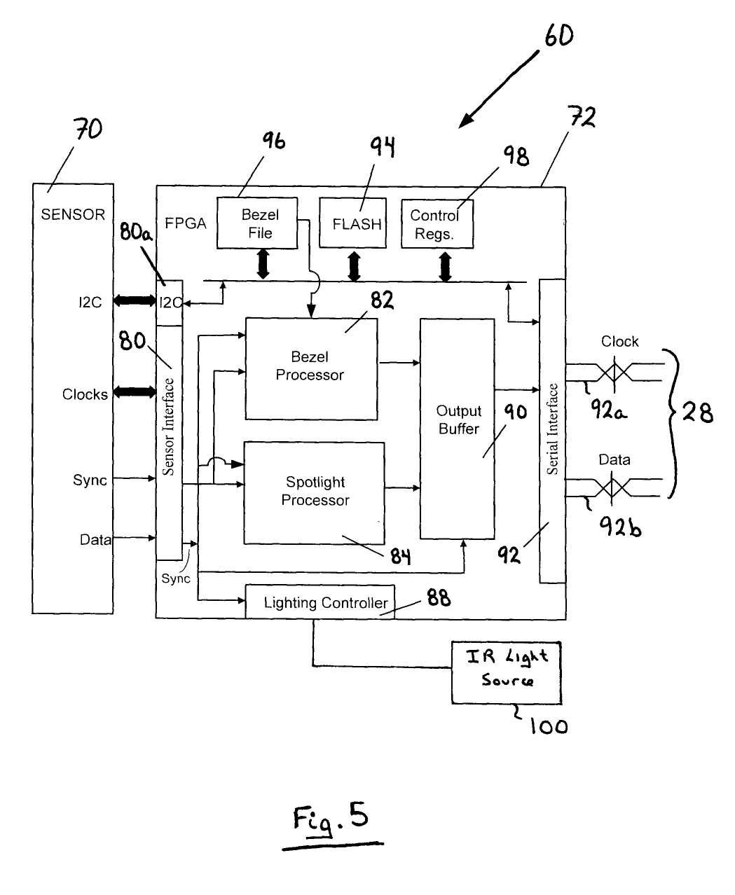

Turning now to FIGS. 4A and 5, one of the imaging assemblies 60 is better illustrated. As can be seen, each imaging assembly 60 comprises an image sensor 70 that communicates with signal processing circuitry 72. In this embodiment, the image sensor 70 of each imaging assembly 60 is of the type manufactured by Micron under model No. MT9V023 and is fitted with an 880 nm lens of the type manufactured by Boowon under model No. BW25B giving the image sensor 70 a field of view greater than ninety (90) degrees. Of course, those of skill in the art will appreciate that other commercial or custom image sensors may be employed.

In this embodiment, the signal processing circuitry 72 is implemented on an integrated circuit such as for example a field programmable gate array (FPGA) chip and is assembled on a printed circuit board with the image sensor 70 as shown in FIG. 4A. Alternatively, the image sensor 70 and the signal processing circuitry 72 may be fabricated on a single integrated circuit die 102 as shown in FIG. 4B. The signal processing circuitry 72 comprises a sensor interface 80 that provides image data to a bezel processor 82, and to a spotlight processor 84. The sensor interface 80 also provides synchronization information to a lighting controller 88 and to an output buffer 90. The output buffer 90 is coupled to a serial interface 92 which itself is coupled to the clock and data lines 92a and 92b, respectively, of the serial bus 28. The sensor interface 80 includes an I²C bus interface 80a that controls the transmission of data between the image sensor 70 and the signal processing circuitry 72. All input/output and clock lines of the image sensor 70 are wired directly to the signal processing circuitry 72 so that no support hardware is required. Data coming through the serial interface 92 that is addressed to the image sensor 70 is reformatted by the I²C bus interface 80a and sent directly to the image sensor 70.

The signal processing circuitry 72 also comprises 4 Mbits of flash memory 94, a bezel file 96 and control registers 98. The flash memory 94 contains sufficient space for two FPGA chip configuration files and about 1 Mbit for user information. One configuration file is used to reprogram the FPGA chip for a fail safe or factory diagnostics mode. The user information memory is used to store image sensor parameters, serial numbers and other information relevant to the image sensor.

The lighting controller 88 is connected to a radiation source such as an infrared (IR) light source 100 comprising a plurality of IR light emitting diodes (LEDs) and associated lens assemblies. The total power for the IR light source 100 in this embodiment is 300 mW. The IR light source 100 is only turned on during the exposure times of the image sensor 70, resulting in a duty cycle of approximately 8% and an average power draw of approximately 25 mW. The control signals for the IR light source 100 are supplied by the lighting controller 88 in response to synchronization signal output from the image sensor 70 that is received by the lighting controller 88 via the sensor interface 80.

The FPGA chip in this embodiment comprises a security system that includes a unique identifier for the FPGA chip (64 bytes) and a one-time programmable security register (64 bytes). The security register can be programmed in the factory with a unique code that unlocks the FPGA chip. Any attempt to copy a configuration file from one FPGA chip to another FPGA chip causes the FPGA chip to shut down. The FPGA chip also includes multiple on-chip or internal clocks. The clock of the image sensor 70 and all FPGA internal clocks are synthesized from clock input received by the serial interface 92 via the clock line 92a of the serial bus 28 without an external crystal. Generating the high-frequency clocks locally on the imaging assembly 60 helps to reduce electromagnetic interference (EMI). The FPGA chip in this embodiment also comprises approximately 200,000 gates, 288 Kbits of on chip static memory, and 195 I/O pins. For example, the Xilinx XC3S200AN FPGA chip could be used. The static memory is allocated as follows. The bezel file 96 uses 16 kbit of static memory, the internal register of the bezel processor 92 uses 16 kbit of static memory, the internal register of the spotlight processor 84 uses 16 kbit of static memory, and the output buffer 90, which is double buffered, uses 32 kbit of static memory.

The signal processing circuitry 72 serves multiple purposes. The primary function of the signal processing circuitry 72 is to perform pre-processing on the image data generated by the image sensor 70 and stream the results to the central hub 26. The signal processing circuitry 72 also performs other functions including control of the IR light source 100, lens assembly parameter storage, anti-copy security protection, clock generation, serial interface, and image sensor synchronization and control.

The central hub 26 comprises a universal serial bus (USB) micro-controller that is used to maintain the serial links to the imaging assemblies 60, package the image information received from the imaging assemblies 60 into USB packets, and send the USB packets over the USB cable 32 to the computing device 30 for further processing.

Communications between the central hub 26 and the imaging assemblies 60 over the serial bus 28 is bidirectional and is carried out synchronously at a rate of 2 Mbit/s in each direction. The communication rate may be increased to reduce latency if desired. The clock and data lines 92a and 92b, respectively, of the serial bus 28 carry a differential pair of clock and data signals. The clock line 92a is driven from the central hub 26 and serves the dual purpose of serially clocking image data and providing a reference clock for the imaging assemblies 60. When data is on the data line 92b of the serial bus 28, the clock and data lines 92a and 92b are driven by the central hub 26 in opposite polarity. When the serial bus 28 is released, pull-up resistors (not shown) pull both the clock and data lines high. The central hub 26 pulls both the clock and data lines low simultaneously to reset the imaging assemblies 60. The central hub 26 is therefore able to reset and release all the printed circuit boards together to synchronize the imaging assemblies 60. The serial bus 28 is in the form of a ribbon cable for short distances and a cat-5 cable for longer distances.

The central hub 26 also comprises a switching voltage regulator to provide an input 3.3V logic supply voltage to each imaging assembly 60 that is used to power the image sensors 70. A 1.2V logic supply voltage for the FPGA chip is generated from the 3.3V logic supply voltage in each imaging assembly 60 by a single linear voltage regulator (not shown). External current regulators, storage capacitors, and switching capacitors for running the IR light sources 100 are also contained in the central hub 26. The switching voltage regulator to run the IR light sources 100 is approximately 0.5V above the LED forward bias voltage.

The interactive input system 20 is designed to detect a passive pointer such as for example, a user's finger F, a cylinder or other suitable object that is brought into proximity with the display surface 24 and within the fields of view of the imaging assemblies 60.

The general operation of the interactive input system 20 will now be described. Each imaging assembly 60 acquires image frames looking generally across the display surface 24 within the field of view of its image sensor 60 at the frame rate established by the signal processing circuitry clock signals. When the IR light sources 100 are on, the LEDs of the IR light sources flood the region of interest over the display surface 24 with infrared illumination. Infrared illumination that impinges on the retro-reflective bands of the bezel segments 40, 42 and 44 is returned to the imaging assemblies 60. As a result, in the absence of a pointer, each imaging assembly 60 sees a bright band having a substantially even intensity over its length. When a pointer is brought into proximity with the display surface 24, the pointer occludes infrared illumination reflected by the retro-reflective bands of the bezel segments 40, 42 and 44. As a result, the pointer appears as a dark region that interrupts the bright band in captured image frames. The signal processing circuitry 72 processes the image frames to determine if one or more pointers are captured in the image frames and if so, to generate pointer data.

The central hub 26 polls the imaging assemblies 60 at a set frequency (in this embodiment 120 times per second for an image capture frequency of 960 frames per second (fps)) for pointer data and performs triangulation on the pointer data to determine pointer position data. The central hub 26 in turn transmits pointer position data and/or image assembly status information to the computing device 30. In this manner, pointer position data transmitted to the computing device 30 can be recorded as writing or drawing or can be used to control execution of application programs executed by the computing device 30. The computing device 30 also updates the display output conveyed to the display unit so that the presented image reflects the pointer activity. The central hub 26 also receives commands from the computing device 30 and responds accordingly as well as generates and conveys diagnostic information to the imaging assemblies 60.

Initially, an alignment routine is performed to align the image sensors 70. During the alignment routine, a pointer is held in the approximate center of the display surface 24. Following image frame capture, subsets of the pixels of the image sensors 70 are then selected until a subset of pixels for each image sensor 70 is found that captures the pointer and the pointer tip on the display surface 24. This alignment routine allows for a relaxation in mechanical mounting of the image sensors 70. The identification of the pointer tip on the display surface 24 also gives calibration information for determining the row of pixels of each image sensor 70 that corresponds to actual pointer contacts made with the display surface 24. Knowing these pixel rows allows the difference between pointer hover and pointer contact to be readily determined.

In this embodiment, since a computing device display is projected onto the display surface 24, during the alignment routine several known coordinate locations are also displayed on the display surface 24 and the user is prompted to touch these coordinate locations in sequence using the pointer so that the subset of pixels for each of image sensor 70 includes all of these touch coordinate locations as well. Calibration data is then stored for reference so that pointer contacts on the display surface 24 can be mapped to corresponding areas on the computer display.

As mentioned above, each imaging assembly 60 acquires image frames looking generally across the display surface 24 within its field of view. The image frames are acquired by the image sensors 70 at intervals in response to the clock signals received from the signal processing circuitry 72. The signal processing circuitry 72 in turn reads each image frame from the image sensor 70 and processes the image frame to determine if a pointer is located in the image frame and if so, extracts pointer and related pointer statistical information from the image frame. To avoid processing significant numbers of pixels containing no useful information, several components of the signal processing circuitry 72 pre-process the image frame data as will be described.

The pointer data generated by the signal processing circuitry 72 of each imaging assembly 60 is only sent to the central hub 26 when the imaging assembly 60 is polled by the central hub 26. The signal processing circuitries 72 create pointer data faster than the central hub 26 polls the imaging assemblies 60. However, the central hub 26 may poll the imaging assemblies 60 at a rate synchronous with the creation of the processed image data. Processed image data that is not sent to the central hub 26 is overwritten.

When the central hub 26 polls the imaging assemblies 60, frame sync pulses are sent to the imaging assemblies 60 to initiate transmission of the pointer data created by the signal processing circuitries 72. Upon receipt of a frame sync pulse, each signal processing circuitry 72 transmits pointer data to the central hub 26 over the data lines 92b of the serial bus 28. The pointer data that is received by the central hub 26 is auto-buffered into the central hub processor.

After the central hub processor has received pointer data from each of the imaging assemblies 60, the central hub processor processes the received pointer data to calculate the position of the pointer in (x,y) coordinates relative to the display surface 24 using triangulation in a well known manner such as that described in above-incorporated U.S. Pat. No. 6,803,906 to Morrison et al. The calculated pointer coordinate is then conveyed to the computing device 30. The computing device 30 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computing device 26.

As mentioned above, several components of the signal processing circuitry 72 pre-process the image data to create the pointer data. The bezel processor 82 performs pre-processing steps to improve the efficiency of the interactive input system signal processing operations. One of these pre-processing steps is ambient light reduction. The image sensors 70 are run at a much higher frame rate than is required and the IR light sources 100 are turned on during alternate image frames. The bezel processor 82 subtracts image frames captured while the IR light sources 100 are on from image frames captured while the IR light sources 100 are off. Ambient light is relatively constant across image frames so the ambient light is canceled during this process and does not appear in the difference image frames. In this embodiment, the image sensors 70 run at a frame rate 8 times the desired output rate. For every eight image frames captured, four image fames are captured while the IR light sources 100 are on and four frames are captured while the IR light sources 100 are off The four frames captured while the IR light sources 100 are off are then subtracted from the four frames captured while the IR light sources 100 are on and the resultant difference frames are added to produce one image.

The bezel processor 82 also performs signal processing operations to capture and track one or more pointers on the display surface 24. The output of the bezel processor 82 is a single number for each column of the image data that indicates the presence of a pointer. In this embodiment, the bezel processor 82 performs continuity calculations to identify the pointer in the image data. The bezel processor 82 adds a number of pixels in a column in the image data corresponding to a bright part of the bezel and then subtracts the same number of pixels from the image data corresponding to a dark part just above the bezel. If no pointer is present then this will show very high contrast. If a pointer is present, whether bright or dark, the lighting will be approximately equal in both regions and the contrast will be low. The location of the bezel and the number of points to add/subtract are stored in the bezel file 96.

Error checking is done by the bezel processor 82 regardless of the type of bezel and pointer used. The bezel processor monitors the image sensor 70 to determine if a very strong light source has saturated the image sensor. If the image sensor is saturated, a flag is set. The flag triggers a warning message to be displayed so that a user can take steps to remove or attenuate the very strong light source.

While the bezel processor 82 is the main means of capturing and tracking objects on the display surface 24, the spotlight processor 84 is a secondary mechanism that allows regions in the image data that may contain a pointer to be extracted. Unlike the bezel processor, the spotlight processor 84 employs feedback from the central hub 26. If the feedback is delayed or incorrect, then a pointer can still be detected with reduced functionality/accuracy. The spotlight processor 84 employs a movable window, preferably 32×32 pixels or 64×16 pixels that is extracted from the image data and sent back to the central hub 26 after light processing and zooming. The central hub 26 can select several lighting modes for the spotlight that are independent of the bezel processor 82. These lighting modes include ambient light rejection, bezel light rejection, and normal exposure (ambient and bezel light). The central hub 26 can also specify that the spotlight be zoomed out to view larger targets. For example, to capture a target that is 150 pixels wide the central hub specifies that the image be zoomed out by a factor of 4 in the horizontal direction in order to fit into a 64×16 pixel window. Zooming is achieved by binning a number of pixels together.

To track moving pointers, the central hub 26 specifies the estimated position and velocity of the pointer in its current image frame and reports that back to the spotlight processor 84. The spotlight processor 84 observes the frame number of the image frame just acquired by the image sensor 70 and adjusts the spotlight position accordingly to account for any latency from the central hub 26. The spotlight can be scanned over the full image data if necessary to get a full-frame view at a very slow rate. This slow scan is done when the interactive input system 20 is initialized to determine the location of the bezel. The output format for the spotlight is 8-bit block floating point (one exponent for the whole image) to allow for the large dynamic range.

Rather then being fabricated as a FPGA chip, the signal processing circuitry may take other forms. For example, in the embodiments shown in FIGS. 6A and 6B, the signal processing circuitry is in the form of a digital signal processor (DSP). The DSP may be assembled on a printed circuit board with the image sensor as shown in FIG. 6A or alternatively, the digital signal processor may be fabricated on a single integrated circuit die with the image sensor as shown in FIG. 6B. In the embodiments of FIGS. 7A and 7B, the signal processing circuitry may be in the form of a combination of custom circuitry on an application specific integrated circuit (ASIC) and a micro-DSP. The custom circuitry and micro-DSP may be assembled on a printed circuit board with the image sensor as shown in FIG. 7A or alternatively, the custom circuitry and micro-DSP may be fabricated on a single integrated circuit die with the image sensor as shown in FIG. 7B. The micro-DSP may also be embodied in the ASIC. In the embodiments of FIGS. 6A to 7B, in addition to the functionality described above, the signal processing circuitry performs additional functions, including generating pointer data from image data generated by the image sensor, and determining pointer hover and contact status. These additional functions are described in above-incorporated U.S. Pat. No. 6,803,906 to Morrison et al.

Although the image sensors 70 are shown as being positioned adjacent the bottom corners of the display surface 24, those of skill in the art will appreciate that the image sensors may be located at different positions relative to the display surface. Also, although the illumination sources 52 are described as IR light sources, those of skill in the art will appreciate that other suitable radiation sources may be employed.

The interactive input system may of course take other forms. For example, the retro-reflective bezel segments may be replaced with illuminated bezel segments. The illuminated bezel segments may be as described in U.S. Pat. No. 6,972,401 to Akitt et al. and assigned to SMART Technologies ULC assignee of the subject application, the content of which is incorporated herein by reference. The radiation modulating technique as described in U.S. patent application Ser. No. 12/118,521 to McGibney et al., the content of which is incorporated by reference may also be employed to reduce interference and allow information associated with various IR light sources to be separated. If desired, the on-time of the IR light sources 100 may be controlled independently of the exposure time of the image sensors 70 in order to create a balance of ambient and active lighting. For example, the image sensor exposure times may be increased while keeping the time that the IR light sources 100 are on the same to let in more ambient light. The on-time of each IR light source can also be controlled independently. This allows the output power of the IR light sources to be dynamically equalized to get consistent lighting

Although the interactive input system 20 is described above as detecting a passive pen tool such as a finger, those of skill in the art will appreciate that the interactive input system can also detect active pointers that emit light or other signals when in the proximity of the display surface 24, or a stylus perhaps having a retro-reflective or highly reflective tip in combination with a light-absorbing bezel.

When an active pointer is used without an illuminated bezel, or when a reflective passive pointer is used with a light absorbing bezel, during signal processing operations to capture and track one or more pointers on the display surface, the bezel processor 82 performs vertical intensity profile calculations to identify the pointer in the image data. The vertical intensity profile is the sum of a number of pixels in a vertical column in the image data corresponding to the bezel. The location of the bezel at each column and the number of points to sum is determined in advance by the central hub 26 and is loaded into a bezel file 96 onboard the FPGA chip.

One of ordinary skill in the art will appreciate that the functionality of central hub 26 could be incorporated into the circuitry of one or more of the imaging assemblies 60, one benefit being a reduction in overall cost. In such a configuration, the imaging assembly with central hub functionality would be treated as the primary assembly. Alternatively, each imaging assembly could have such hub functionality, and a voting protocol employed to determine which of the imaging assemblies would operate as the central or primary hub. Alternatively, the imaging assembly connected to the PC would default as the primary assembly.

One of ordinary skill in the art will appreciate that the assembly, central hub 26 and computing device 30 could be incorporated into a single device, and that the signal processing circuitry could be implemented on a graphics processing unit (GPU) or comprise a cell-based processor.

It will be understood that, while the central hub 26 is described above as polling the imaging assemblies 60 at 120 times per second for an image capture frequency of 960 fps, other image capture rates may be employed depending upon the requirements and/or limitations for implementation. Also, although the communication lines 28 are described as being embodied as a serial bus, those of skill in the are will appreciate that the communications lines may also be embodied as a parallel bus, a universal serial bus (USB), an Ethernet connection or other suitable wired connection. Alternatively, the assembly 22 may communicate with the central hub 26 over a wireless connection using a suitable wireless protocol such as for example Bluetooth, WiFi, ZigBee, ANT, IEEE 802.15.4, Z-Wave etc. In addition, although the central hub 26 is described as communicating with the computing device 30 via a USB cable 32, alternatively, the central hub 26 may communicate with the computing device 30 over another wired connection such as for example, a parallel bus, an RS-232 connection, an Ethernet connection etc. or may communicate with the computing device 30 over a wireless connection using a suitable wireless protocol such as for example Bluetooth, WiFi, ZigBee, ANT, IEEE 802.15.4, Z-Wave etc.

While an alignment routine to align the image sensors has been set out above, alternative alignments routines may be employed. For example, in some embodiments, markers may be positioned on the bezel(s) or at other positions and detected in order to enable the interactive input system to self-calibrate without significant user interaction. Alternatively, the retro-reflective bezels themselves may be detected and the captured pixels containing the retro-reflective bezels employed to determine the rows of pixels for each image sensor 70. In general, as the number of rows can be reduced, the frame rate of image processing can be increased.

Although embodiments have been described with reference to the drawings, those of skill in the art will appreciate that variations and modifications may be made without departing from the spirit and scope thereof as defined by the appended claims.

1. An interactive input system comprising:
at least two imaging assemblies capturing image frames of a region of interest from different vantages; and
processing structure processing image frames captured by said imaging assemblies to determine the location of a pointer within the region of interest, wherein each imaging assembly comprises an image sensor and integrated signal processing circuitry.

2. The system of claim 1, wherein the signal processing circuitry and image sensor of each imaging assembly are mounted on a common printed circuit board.

3. The system of claim 1, wherein the signal processing circuitry and image sensor of each imaging assembly is fabricated on an integrated circuit die.

4. The system of claim 1, wherein the signal processing circuitry is implemented on a field programmable gate array (FPGA).

5. The system of claim 1, wherein the signal processing circuitry is implemented on a digital signal processor (DSP).

6. The system of claim 1, wherein the signal processing circuitry is at least partly implemented on an application specific integrated circuit (ASIC).

7. The system of claim 1, wherein the signal processing circuitry comprises circuitry implemented on an application specific integrated circuit (ASIC).

8. The system of claim 7, wherein the signal processing circuitry comprises a micro-DSP.

9. The system of claim 8, wherein the micro-DSP is implemented on the ASIC.

10. The system of claim 8, wherein the ASIC, micro-DSP and image sensor are mounted on a common printed circuit board.

11. The system of claim 8, wherein the ASIC, micro-DSP and image sensor are fabricated on a single integrated circuit die.

12. The system of claim 1, wherein the signal processing circuitry of each imaging assembly generates pointer data from image data generated by the associated image sensor.

13. The system of claim 12, wherein the signal processing circuitry of each imaging assembly determines pointer hover and contact status from the image data.

14. The system of claim 1, wherein the processing structure comprises a lighting controller for driving radiation sources that illuminate the region of interest.

15. The system of claim 1, wherein, the processing structure comprises a spotlight processor to extract regions of image frames containing a pointer.

16. The system of claim 1, wherein the processing structure comprises a bezel processor to track pointers in image frames.

17. The system of claim 14, wherein the lighting controller deactivates the radiation sources when the imaging assemblies are inactive.

18. The system of claim 17, wherein the lighting controller synchronizes operation of the radiation sources with the image frame capture rates of said imaging assemblies.

19. The system of claim 16, wherein the bezel processor processes captured image frames to reduce the effect of ambient light.

20. The system of claim 1, wherein the processing structure is a cell-based processor.

21. The system of claim 1, wherein the processing structure is a graphics processor.

22. An interactive input system comprising:
at least one imaging device having a field of view looking into a region of interest; and
at least one radiation source emitting radiation into said region of interest, wherein during image frame capture by said at least one imaging device, the operation of the at least one radiation source is synchronized with the exposure time of said at least one imaging device.
